(19) United States
(12) Patent Application Publication
(10) Pub. No.: US 2016/0373464 A1
(43) Pub. Date: Dec. 22, 2016

(54) COMMUNICATION SYSTEM, METHOD AND BASE STATION

(71) Applicant: FUJITSU LIMITED, Kawasaki-shi (JP)

(72) Inventor: Shunsuke KIKUCHI, Shinagawa (JP)

(73) Assignee: FUJITSU LIMITED, Kawasaki-shi (JP)

(21) Appl. No.: 15/185,432

(22) Filed: Jun. 17, 2016

(30) Foreign Application Priority Data
Jun. 22, 2015 (JP) 2015-125007

(51) Int. Cl. H04L 29/06; H04W 12/02

(52) U.S. Cl. CPC H04L 63/145; H04W 12/02; H04L 63/20; H04W 80/04

(57) ABSTRACT

A communication system includes an information processing apparatus storing a plurality of filter rules corresponding to respective application programs, a first base station covering a first area, and a second base station covering a second area overlapping the first area, wherein the second base station is configured to couple to a terminal device located in the second area, store a first filter rule corresponding to a first application program, and filter a communication caused when the terminal device executes the first application program, and the first base station is configured to acquire, from the second base station, application program information indicating the first application program, determine whether to acquire, from the information processing apparatus, the first filter rule corresponding to the first application program based on a first overlapping state of the first area and the second area, and acquire the first filter rule from the information processing apparatus.

### CROSS-REFERENCE TO RELATED APPLICATION

This application is based upon and claims the benefit of priority of the prior Japanese Patent Application No. 2015-125007, filed on Jun. 22, 2015, the entire contents of which are incorporated herein by reference.

### FIELD

The present embodiments are related to a communication system, a method and a base station.

### BACKGROUND

Because of the prevalence of smart devices such as smartphones and tablets and radio communication techniques, it is possible to be coupled to a network and use information services not only in homes and offices but also in various places.

Meanwhile, malware and so forth targeting the smart devices also increases and risk of suffering damage such as intrusion into an information processing system and leakage of information also increases.

Accordingly, a mechanism to set a filter for communications from the smart device to prevent intrusion from the outside and unintended leakage of information from the inside is being considered. The filter is set in units of an application program (hereinafter, referred to as application or App) executed on the smart device. By setting the filter in units of an application, communications with an object (site) that is not intended by a user can be clarified.

For example, an information processing device that carries out radio communications with a portable terminal and is managed by a business operator that provides communication services using the portable terminal via a public IP network and a base station device that can communicate with the Internet are known. The base station device includes filtering means that carries out filtering an access to the Internet by the portable terminal. The filtering means receives permission-or-non-permission information indicating whether to permit access to the Internet by the portable terminal from the information processing device and determines the contents of the permission-or-non-permission information. If the permission-or-non-permission information indicates permission as the result of the determination, the filtering means accesses the Internet and transmits data transmitted from the access destination to the portable terminal. On the other hand, if the permission-or-non-permission information indicates non-permission, the filtering means deletes the access.

As one example of the related art, International Publication Pamphlet No. WO 2009/139460 is known.

### SUMMARY

According to an aspect of the invention, a communication system includes an information processing apparatus storing a plurality of filter rules corresponding to respective application programs, a first base station covering a first area, and a second base station covering a second area overlapping the first area, wherein the second base station is configured to couple to a terminal device located in the second area, store a first filter rule corresponding to a first application program, and filter a communication caused when the terminal device executes the first application program, and the first base station is configured to acquire, from the second base station, application program information indicating the first application program, determine whether to acquire, from the information processing apparatus, the first filter rule corresponding to the first application program indicated by the application program information based on a first overlapping state of the first area and the second area, and acquire, based on the determination, the first filter rule from the information processing apparatus.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is one example of a filter system for smart devices;

FIG. 2 illustrates one example of a control device in a present embodiment;

FIG. 3 is one example of a filter system for smart devices in a present embodiment;

FIG. 4 is a diagram for explaining an overlapping relationship among a coverage area of a mobile base station X and coverage areas of neighboring mobile base stations A, B, C, and D when a directivity of an antenna changes in a present embodiment;

FIG. 5 is a diagram for explaining decision method 1 (method 1) of preloaded filter rules of applications in a present embodiment;

FIG. 6 is a diagram for explaining decision method 2 (method 2) of preloaded filter rules of applications in a present embodiment;

FIG. 7 is a diagram for explaining an acquisition method (method 3) of preloaded filter rules of applications in a present embodiment;

FIG. 8 illustrates a first example of a mobile base station and a filter node that operates on the mobile base station in a present embodiment;

FIG. 9 illustrates a second example of a mobile base station and a filter node that operates on the mobile base station in a present embodiment;

FIG. 10 illustrates a third example of a mobile base station and a filter node that operates on the mobile base station in a present embodiment;

FIG. 11 illustrates one example of a coverage information table 45 in a present embodiment;

FIG. 12A and FIG. 12B illustrate one example of a rule table in a present embodiment;

FIG. 13 illustrates one example of a filter node deployment state DB in a present embodiment;

FIG. 14 illustrates one example of a number-of-accommodated-devices table in a present embodiment;

FIG. 15 illustrates a flow of preloading processing of filter rule information when an antenna state is changed in a present embodiment;

FIG. 16 illustrates a flow of start processing of application use in a smart device in a case in which a rule table is managed by an LRU method in a present embodiment;

FIG. 17 illustrates a flow of start processing of application use in a smart device in a case in which a rule information is managed by an LFU method in a present embodiment;

FIG. 18 illustrates a flow of end processing of application use in a smart device in a present embodiment;

FIG. 19A and FIG. 19B illustrate flows of transmission processing of an App list in a present embodiment;

FIG. 20 illustrates a processing flow of collective acquisition of filter rules from a filter server in a present embodiment;

FIG. 21 illustrates a processing flow of individual acquisition of filter rules from a filter server in a present embodiment; and

FIG. 22 is one example of a configuration block diagram of a hardware environment of a computer that executes a program in a present embodiment.

### DESCRIPTION OF EMBODIMENTS

In a system accessible from the outside, a filter rule prescribed in consideration of security of the system is set and an access determination as to whether access may be permitted is carried out by using the filter rule at the time of coupling from the outside.

It is preferable for filter nodes that carry out the access determination to be set on (or near) base stations because it is necessary to cover the number of accesses from the outside. Each filter node receives a filter rule according to the situation of each filter node among plural filter rules. If the filter nodes are deployed on base stations, the base stations need to acquire the filter rule in consideration of the directivity of the antenna.

However, in the filter nodes that carry out the access determination, the filter rule to be acquired may be unclear because the directivity of the antenna and the use situation of neighboring filter nodes may be unclear.

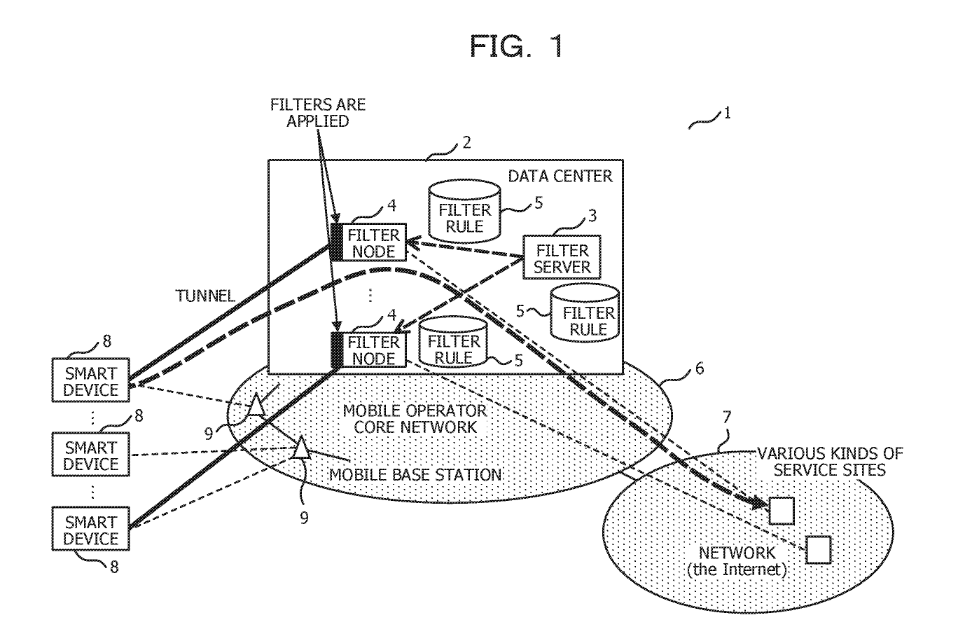

FIG. 1 is one example of a filter system for smart devices. A filter system 1 includes a data center 2, a mobile operator core network 6, a network 7 such as the Internet, and smart devices 8. The data center 2 is included in the core network 6. The network 7 includes various kinds of service sites that exist on the Internet and are constructed by servers or systems that provide various kinds of applications or services.

The data center 2 includes filter nodes 4 and a filter server 3. The filter node 4 is a device that applies a filter to traffic from the smart device 8 or to the smart device 8 in units of an application.

The filter server 3 is a device that holds and manages filter rules 5 serving as the master. The filter rules 5 are managed in units of an application and are created and updated as needed on the filter server 3 to be transferred to the respective filter nodes 4.

In the filter system 1, tunnels are constructed from the smart devices 8 to the filter nodes 4 by using a virtual private network (VPN) or the like and filters according to the filter rule are applied to traffic transmitted and received by the smart devices 8.

Here, suppose that the filter rules 5 that are generated on the filter server 3 and correspond to all applications are transferred to each filter node 4 in advance. In this case, for example when use of the filter system 1 is changed from optional use to essential use, the amount of coupled traffic from the smart devices 8 to the filter nodes 4 increases due to increase in the number of users of the filter system 1. As a result, the band of the mobile core network (entry to the data center) is compressed.

Then, for example, disposing the filter nodes 4 near the smart devices 8 in a finely-distributed manner by disposing the filter nodes 4 on mobile base stations 9, or the like, is considered. Avoiding the concentration of the amount of traffic in the core network by the distributed disposing is considered.

However, in the case of disposing the filter node function on the mobile base station 9, the resources are limited in the mobile base station 9 in the first place and the storage capacity that can be used by the filter node 4 operated on the mobile base station 9 is limited. Therefore, it is impossible to transfer all pieces of filter data to the filter nodes 4 on the mobile base stations 9 in advance.

Furthermore, if the filter data is transferred at all, the filter data needs to be selected so as to fall within the storage capacity. However, the mobile base station 9 does not know which application the user wants to use, and is incapable of controlling the action of the user. Thus, the mobile base station 9 cannot make a determination as to which kind of filter data should be selected as the filter data corresponding to the application, and cannot decide the filter data that should be selected.

Therefore, the user is made to wait for the start of communications until transfer of the filter data corresponding to the relevant application from the filter server 3 to the filter node 4 is requested and acquisition of the filter data by the filter node 4 is completed. As a result, if the filter data corresponding to the application the user wants to use does not exist, the user is made to wait longer until the user can start communications with the original communication destination (various kinds of service sites).

Accordingly, the present embodiment intends to select filter data prior to the user request and transfer the filter data to the filter node set on the base station having a limitation of resources.

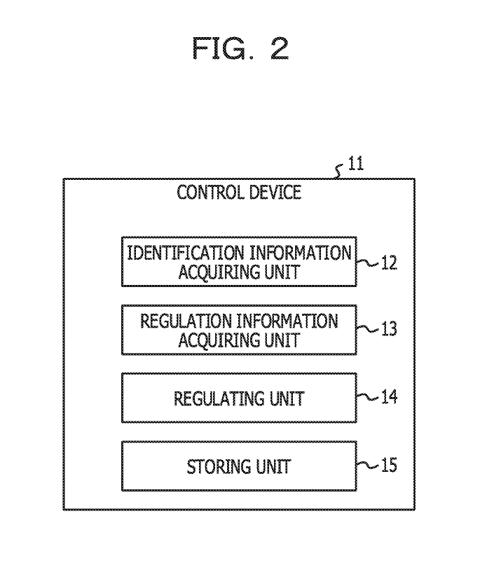

FIG. 2 illustrates one example of a control device in the present embodiment. A control device 11 includes an identification information acquiring unit 12, a regulation information acquiring unit 13, and a regulating unit 14.

The identification information acquiring unit 12 acquires identification information to identify programs corresponding to regulation information from another radio base station having a second radio area that at least partly overlaps with a first radio area in which a radio base station that communicates with an information processing device is capable of communication. Here, the other radio base station holds the regulation information that regulates communication corresponding to programs being used in second communication terminals that communicate with the other radio base station. As one example of the identification information acquiring unit 12, an App list acquiring unit 52 to be described later is cited.

The regulation information acquiring unit 13 acquires the regulation information from the information processing device on the basis of the overlapping rate of the second radio area with respect to the first radio area and the identification information. As one example of the regulation information acquiring unit 13, a rule acquiring unit 57 to be described later is cited.

The regulating unit 14 regulates communication based on programs used in first communication terminals that carry out communication via the radio base station by using the acquired regulation information. As one example of the regulating unit 14, a filter unit 54 to be described later is cited.

By making the configuration in this manner, filter information having high value of use is applied to the radio base station according to the regulation information applied in the communication areas of the surrounding radio base stations.

The control device 11 further includes a storing unit 15. The storing unit 15 stores the overlapping rates set corresponding to the combinations of the angle of the antenna of the radio base station and the angle of the antenna of another base station. The identification information acquiring unit 12 executes the following processing if the angle of the antenna of the radio base station and the angle of the antenna of another radio base station adjacent to the radio base station are input. In other words, the identification information acquiring unit 12 acquires, from the storing unit 15, the overlapping rate corresponding to the input angle of the antenna of the radio base station and the angle of the antenna of the other radio base station adjacent to the radio base station.

By making the configuration in this manner, the overlapping rate of the radio areas is acquired.

The regulation information acquiring unit 13 calculates the use rates of programs on the basis of the overlapping rates and the programs being used in the second radio area. The regulation information acquiring unit 13 decides the identification information corresponding to the regulation information to be used in the radio base station on the basis of the use rates of the programs. The regulation information acquiring unit 13 acquires the regulation information corresponding to the decided identification information from the information processing device.

By making the configuration in this manner, the identification information corresponding to the regulation information is decided on the basis of the use rates of the programs and the regulation information corresponding to the decided identification information is acquired.

The regulation information acquiring unit 13 calculates the use rates of programs on the basis of the overlapping rates, the programs being used in the second radio area, and the number of second communication terminals. The regulation information acquiring unit 13 decides the identification information corresponding to the regulation information to be used in the radio base station on the basis of the use rates of the programs. The regulation information acquiring unit 13 acquires the regulation information corresponding to the decided identification information from the information processing device.

By making the configuration in this manner, the use rates of the programs are calculated further in consideration of the number of second communication terminals accommodated in another radio base station.

The identification information acquiring unit 12 acquires the identification information from the radio base station in response to change in the first radio area.

By making the configuration in this manner, filter information having high value of use is applied to the radio base station according to change in the radio area.

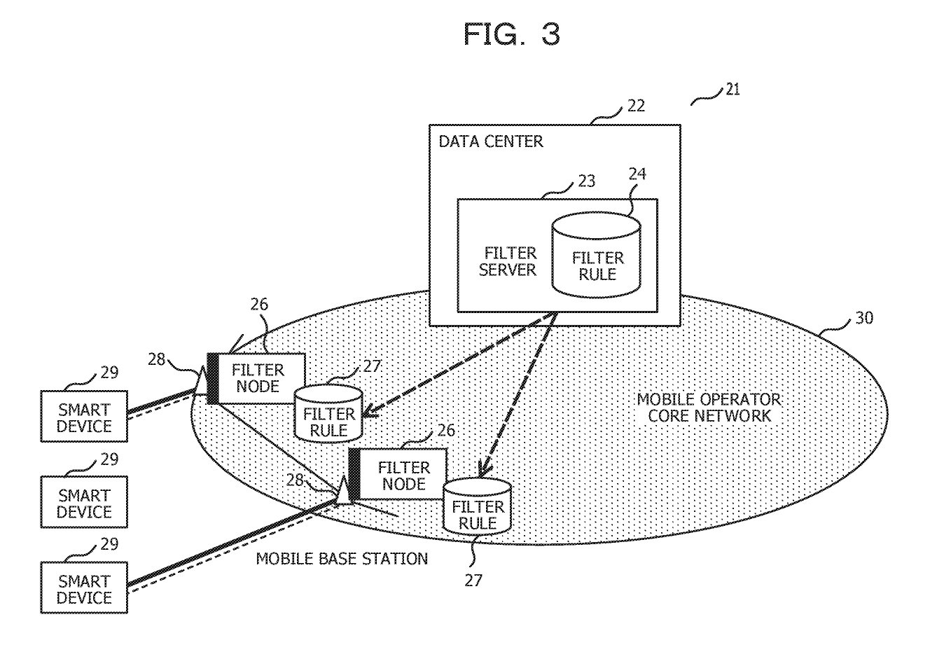

FIG. 3 is one example of a filter system for smart devices in the present embodiment. A filter system 21 includes a data center 22, a mobile operator core network 30, and smart devices 29. The data center 22 and mobile base stations 28 are included in the mobile operator core network 30.

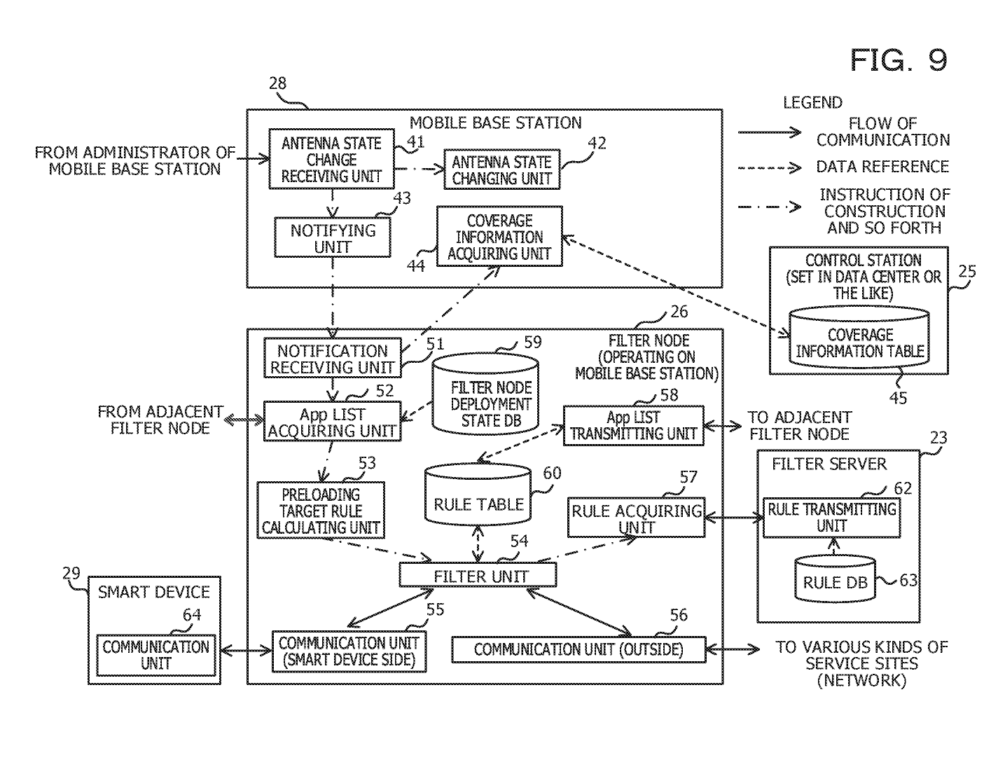

The data center 22 includes a filter server 23. Furthermore, the data center 22 may include a control station 25 (FIG. 9) as described later. The filter server 23 is a device that holds and manages filter rules (filter rule will be often represented as the “rule” or “rule information”) 24 serving as the master. The filter rules 24 are managed in units of an application and are created and updated as needed on the filter server 23.

The mobile base station 28 is a radio base station that is directly coupled to the smart devices 29 by radio communications. The mobile base station 28 includes a filter node 26. The filter node 26 is a device that applies a filter to traffic from the smart device 29 or to the smart device 29 in units of an application. The filter rules 24 are transferred from the filter server 23 to each filter node 26.

In the filter system 21, tunnels are constructed from the smart devices 29 to the filter nodes 26 by using a VPN or the like and filters according to the filter rule are applied to traffic transmitted and received by the smart devices 29.

In the present embodiment, according to change in the directivity of the antenna of the object mobile base station 28, filter data to be preloaded into the filter node on the object mobile base station is decided from the characteristics of a user request to the neighboring filter node having a coverage area overlapping with the coverage area after the change.

The application used involves locality. For example, a timetable application is used around a station, and an area information application is used downtown, and an application of a restaurant is used in the restaurant. Therefore, in the present embodiment, the locality of the application is utilized. Similarly, for the locality, the filter data of the radio base station having the antenna is changed at the timing when the directivity of this antenna changes.

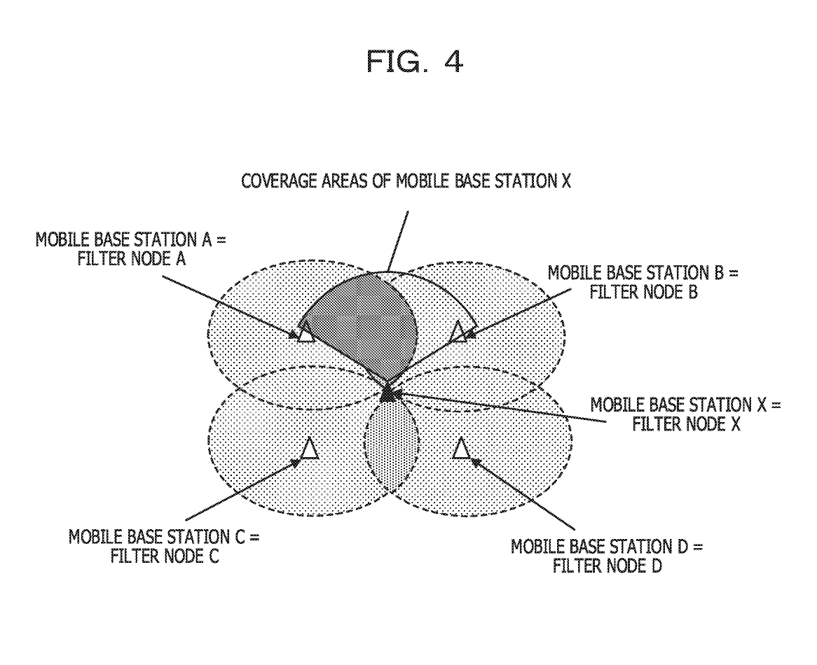

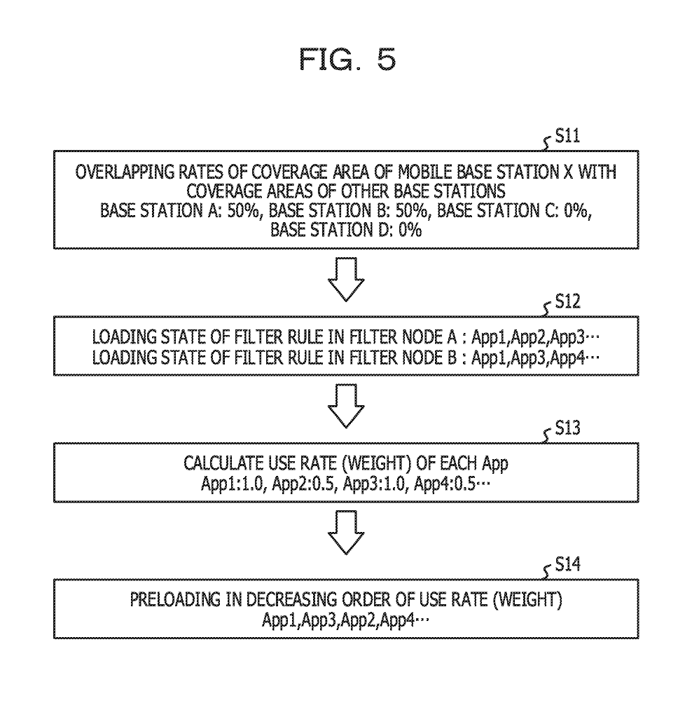

FIG. 4 is a diagram for explaining the overlapping relationship among the coverage area of a mobile base station X and the coverage areas of neighboring mobile base stations A, B, C, and D when the directivity of the antenna changes in the present embodiment. Filter nodes X, A, B, C, and D are included in the mobile base stations X, A, B, C, and D, respectively. FIG. 4 will be described by using FIG. 5.

FIG. 5 is a diagram for explaining decision method 1 (method 1) of preloaded filter rules of applications in the present embodiment. First, the mobile base station X calculates the overlapping rates among the coverage area of the mobile base station X and the coverage areas of other mobile base stations (S11). Here, information on the relationship (overlapping rate) between the setting condition of the orientation of the antenna and the coverage area is created and saved in advance by a function of the mobile base station as described later. Suppose that the overlapping rates are as follows in the case of FIG. 4, base station A: 50%; base station B: 50%; base station C: 0%; and base station D: 0%.

Although the coverage areas of the base stations A, B, C, and D spread over the whole circumference in FIG. 4, each base station has directivity similarly to the mobile base station X in some cases.

Here, suppose that filter rules 27 about App1, App2, App3, . . . are loaded in a filter node A. Furthermore, suppose that the filter rules 27 about App1, App3, App4, . . . are loaded in a filter node B (S12).

In the filter rule 27, the contents of the rule corresponding to the application are managed on the basis of reverse chronological order of the final access date and time (least recently used (LRU) method) or decreasing order of the access frequency (least frequently used (LFU) method). The contents of the rule corresponding to the application are limitation information of a site accessed by the application for example and indicate information on the access destination to which access is permitted.

A filter node X calculates the use rate (weight) of each application on the basis of the filter rules 27 loaded in the filter nodes 26 having the overlapping coverage areas (S13).

For example, if the filter rules 27 are managed by the LRU method, the weight of each application is calculated by the following expression. Hereinafter, a list of the applications corresponding to the filter rules the filter node A has will be referred to as the App list.

weight of each App=(overlapping rate with base station A×whether this App is included in App list of filter node A {1 or 0})+(overlapping rate with base station B×whether this App is included in App list of filter node B {1 or 0})+ . . . .

In the case of the example of FIG. 5, weight of App1=0.5×1+0.5×1+0+0, weight of App2=0.5×1+0.5×0+0+0.

Furthermore, for example if the filter rules 27 are managed by the LFU method, the weight of each application is calculated by the following expression.

weight of each application=(overlapping rate with base station A×whether this App is included in App list of filter node A {1 or 0}×(1/rank of this application in App list of filter node A))+(overlapping rate with base station B×whether this App is included in App list of filter node B {1 or 0}×(1/rank of this App in App list of filter node B))+ . . . .

In the case of the example of FIG. 5, overlapping rate . . . base station A: 50%, base station B: 50%, App list (list with ranking) in filter node A: App1, App2, App3, App list (list with ranking) in filter node B: App1, App3, App4. In this case, weight of App1=0.5×1×(1/1)+0.5×1×(1/1)+0+0, weight of App2=0.5×1×(1/2)+0.5×0+0+0.

The filter node X preloads the filter rules 27 from the filter server 23 in decreasing order of the use rate (weight) (S14).

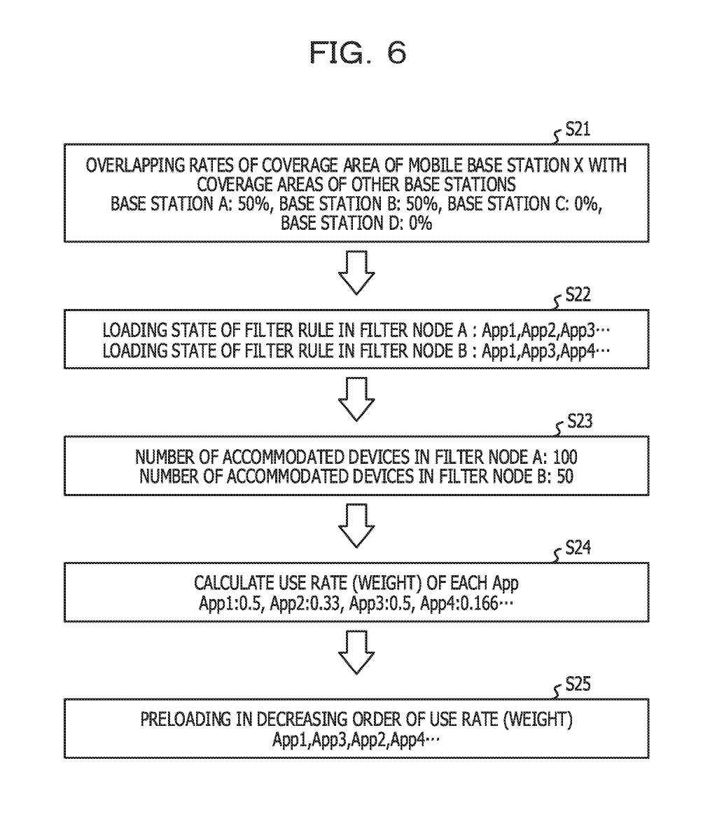

FIG. 6 is a diagram for explaining decision method 2 (method 2) of preloaded filter rules of applications in the present embodiment. In FIG. 6, another method (method in which the number of accommodated smart devices is considered) is illustrated regarding the decision method of preloaded filter rules of applications.

First, the mobile base station X calculates the overlapping rates among the coverage area of the mobile base station X and the coverage areas of other base stations (S21). Suppose that the overlapping rates are as follows in the case of FIG. 4, base station A: 50%; base station B: 50%; base station C: 0%; and base station D: 0%.

Here, suppose that filter rules about App1, App2, App3, . . . are loaded in the filter node A. Furthermore, suppose that filter rules about App1, App3, App4, . . . are loaded in the filter node B (S22). In the filter rule 27, the contents of the rule corresponding to the application are managed on the basis of the LRU method or the LFU method.

Moreover, suppose that the number of communicating smart devices 29 (the number of accommodated devices) is e.g. 100 in the filter node A. Suppose that the number of communicating smart devices 29 (the number of accommodated devices) is e.g. 50 in the filter node B (S23).

The filter node X calculates the use rate (weight) of each application on the basis of the filter rules 27 loaded in the filter nodes having the overlapping coverage areas and the numbers of accommodated devices of the filter nodes (S24).

For example, if the filter rules 27 are managed by the LRU method and the number of accommodated persons of each filter node is considered, the weight of each application is calculated by the following expression.

weight of each App=(overlapping rate with base station A×whether this App is included in App list of filter node A {1 or 0}×(the number of accommodated persons in filter node A/the total number of accommodated persons in all overlapping filter nodes))+ . . . .

In the case of the example of FIG. 6, weight of App1=0.5×1×100/150+0.5×1×50/150, weight of App2=0.5×1×100/150+0.5×0×50/150.

Furthermore, for example, if the filter rules 27 are managed by the LFU method and the number of accommodated persons of each filter node is considered, the weight of each application is calculated by the following expression.

weight of each App=(overlapping rate with base station A×whether this App is included in App list of filter node A {1 or 0}×(the number of accommodated persons in filter node A/the total number of accommodated persons in all overlapping filter nodes)×(1/rank of this App in App list of filter node A))+ . . . .

In the case of the example of FIG. 6, overlapping rate . . . base station A: 50%, base station B: 50%, App list (list with ranking) in filter node A: App1, App2, App3, App list (list with ranking) in filter node B: App1, App3, App4, the number of accommodated devices in filter node A is 100, the number of accommodated devices in filter node B is 50. In this case, weight of App1=0.5×1×(100/150)×(1/1)+0.5×1×(50/150)×(1/1), weight of App2=0.5×1×(100/150)×(1/2), weight of App3=0.5×1×(100/150)×(1/3)+0.5×1×(50/150)×(1/2).

The filter node X preloads the filter rules 27 from the filter server 23 from the filter rule of the application having the highest use rate (weight) in order (S25).

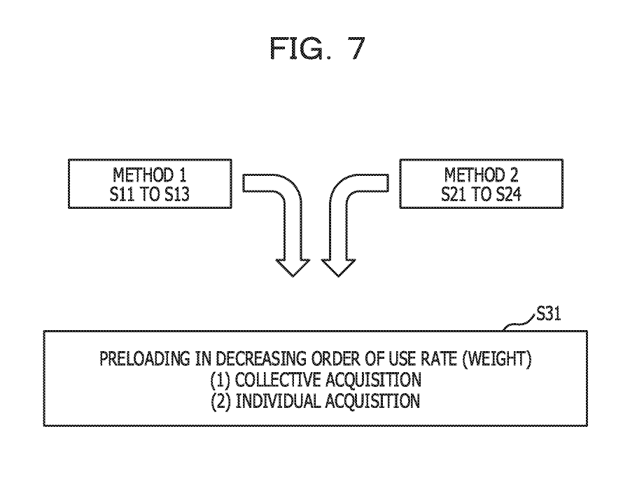

FIG. 7 is a diagram for explaining an acquisition method (method 3) of preloaded filter rules of applications in the present embodiment. Method 3 relates to variations of the preloading processing of method 1 or method 2 (S14 and S25).

As variations of preloading processing (S31), there are (1) a collective acquisition method and (2) an individual acquisition method. The collective acquisition method is a method in which filter rules corresponding to n applications are collectively preloaded from the filter rule of the highest use rate (weight) in order. The individual acquisition method is the following method. For example, filter rules of high use rates (weights) are ranked and the filter rules are preloaded in units of the rank. The free space of the filter node is checked every time the preloading is completed and preloading of the next rank is carried out according to the free space.

By using the above-described methods 1 to 3, filter data in conformity with a user request of each filter node is selected and preloaded when the directivity of the antenna changes. This reduces the possibility that a user is made to wait until the completion of loading of the filter rule when starting communications with various kinds of service sites.

Details of the present embodiment will be described below.

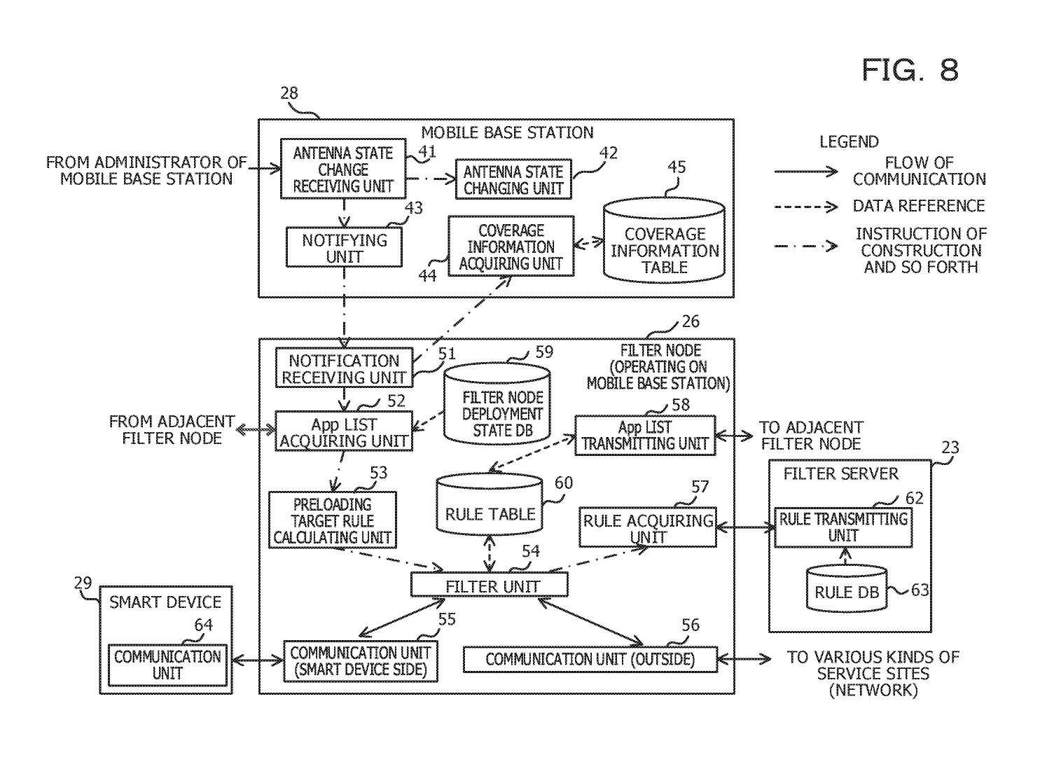

FIG. 8 illustrates a first example of the mobile base station and the filter node that operates on the mobile base station in the present embodiment. The first example is a configuration example of the filter node 26 corresponding to the above-described method 1.

In FIG. 8, the smart device 29, the mobile base station 28, the filter node 26 that operates on the mobile base station 28, and the filter server 23 exist.

The smart device 29 includes a communication unit 64. The communication unit 64 constructs a tunnel between the smart device 29 and the filter node 26 and communicates with the filter node 26 to apply a filter of the filter node and carry out communications with various kinds of service sites (network).

The filter server 23 includes a rule transmitting unit 62 and a rule database (hereinafter, database will be referred to as DB) 63. In the rule DB 63, filter rules are stored in units of an application. The rule transmitting unit 62 acquires, from the rule DB 63, a filter rule corresponding to a request from the filter node 26 and transmits the filter rule to the filter node 26.

The mobile base station 28 includes an antenna state change receiving unit 41, an antenna state changing unit 42, a notifying unit 43, a coverage information acquiring unit 44, and a coverage information table 45.

The antenna state change receiving unit 41 receives instruction information that indicates changing the coverage of the antenna of the mobile base station 28 from an administrator of the mobile base station 28. The antenna state changing unit 42 changes the state of the antenna on the basis of the instruction information.

The notifying unit 43 notifies the filter node 26 of information about the change in the state of the antenna (antenna state change information). The antenna state change information includes the antenna angle of the mobile base station X and the antenna angle of mobile base stations adjacent to the mobile base station X, e.g. the mobile base stations A to D. The coverage information acquiring unit 44 acquires coverage information from the coverage information table 45 on the basis of a request from the filter node 26.

The filter node 26 is a software program that operates on a computer of the mobile base station 28. The filter node 26 includes a notification receiving unit 51, the App list acquiring unit 52, a preloading target rule calculating unit 53, the filter unit 54, a communication unit (smart device side) 55, a communication unit (outside) 56, the rule acquiring unit 57, and an App list transmitting unit 58. Moreover, the filter node 26 includes a filter node deployment state DB 59 and a rule table 60.

The notification receiving unit 51 receives the antenna state change information from the notifying unit 43. The notification receiving unit 51 requests the coverage information acquiring unit 44 to transmit the coverage information on the basis of the antenna state change information and acquires the coverage information from the coverage information acquiring unit 44.

The App list acquiring unit 52 acquires information on base stations on which adjacent filter nodes are deployed (deployment information) from the filter node deployment state DB 59. The App list acquiring unit 52 acquires the overlapping states (overlapping rates) between the coverage area of the mobile base station X and the coverage area of the adjacent mobile base station (filter node) from the acquired deployment information of the filter nodes and the coverage information.

On the basis of the overlapping rates, the App list acquiring unit 52 decides object adjacent nodes from which lists of application names corresponding to the filter rules (App lists) are acquired from the adjacent filter nodes.

The App list acquiring unit 52 requests the object adjacent nodes to transmit the App lists. The App list acquiring unit 52 receives the App lists from the object adjacent nodes.

The preloading target rule calculating unit 53 calculates the use rate (weight) of each application on the basis of the App lists acquired from the object adjacent nodes and the overlapping rates.

The filter unit 54 requests the rule acquiring unit 57 to transmit the filter rule (rule information) acquired from the filter server 23 according to the use rates (weights) calculated by the preloading target rule calculating unit 53. The filter unit 54 stores the rule information of the application obtained as the result of the request in the rule table 60.

In response to the request from the filter unit 54, the rule acquiring unit 57 acquires the rule information of the application from the filter server 23 and responds to the filter unit 54.

The communication unit (smart device side) 55 transfers a communication request from the smart device 29 to the filter unit 54 after the tunnel with the smart device 29 is constructed. When a communication request is issued from the smart device 29, the filter unit 54 applies the filter rule of the application corresponding to the communication request from the rule table 60 and enables communications with an external network via the communication unit (outside) 56.

When a request for the filter rule is issued from the App list acquiring unit 52 of another filter node, the App list transmitting unit 58 extracts the rule information according to the request from the rule table 60 and provides the rule information.

FIG. 9 illustrates a second example of the mobile base station and the filter node that operates on the mobile base station in the present embodiment. In FIG. 9, the operation method and the functions are the same as those in FIG. 8 except for that the coverage information table 45 is provided not in the mobile base station 28 but in the control station 25 set in a data center or the like.

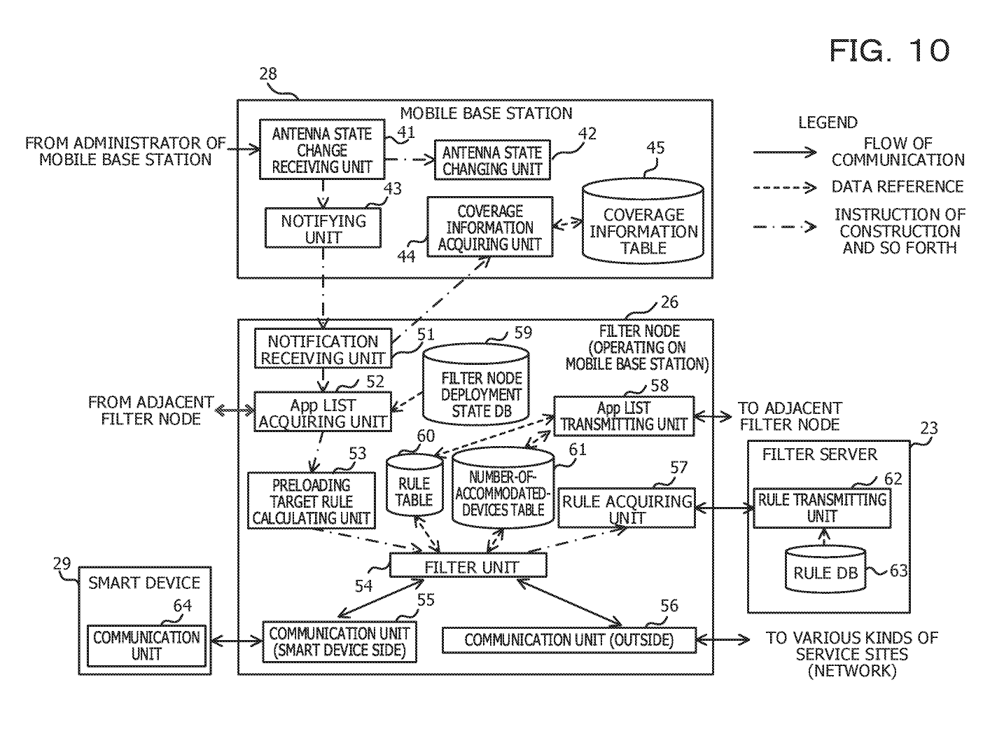

FIG. 10 illustrates a third example of the mobile base station and the filter node that operates on the mobile base station in the present embodiment. The third example is a configuration example of the filter node corresponding to the above-described method 2. The filter node in FIG. 10 is obtained by adding a number-of-accommodated-devices table 61 to the filter node in FIG. 8.

In FIG. 10, the App list acquiring unit 52 receives App lists from object adjacent nodes and acquires the numbers of smart devices accommodated by the adjacent filter nodes (the numbers of accommodated devices).

Furthermore, in FIG. 10, the App list transmitting unit 58 provides the number of smart devices accommodated by this filter node (the number of accommodated devices) as well as the App list.

In the following, common processing will be described on the basis of the configurations of FIG. 8 to FIG. 10 and processing specific to each configuration will be described according to need.

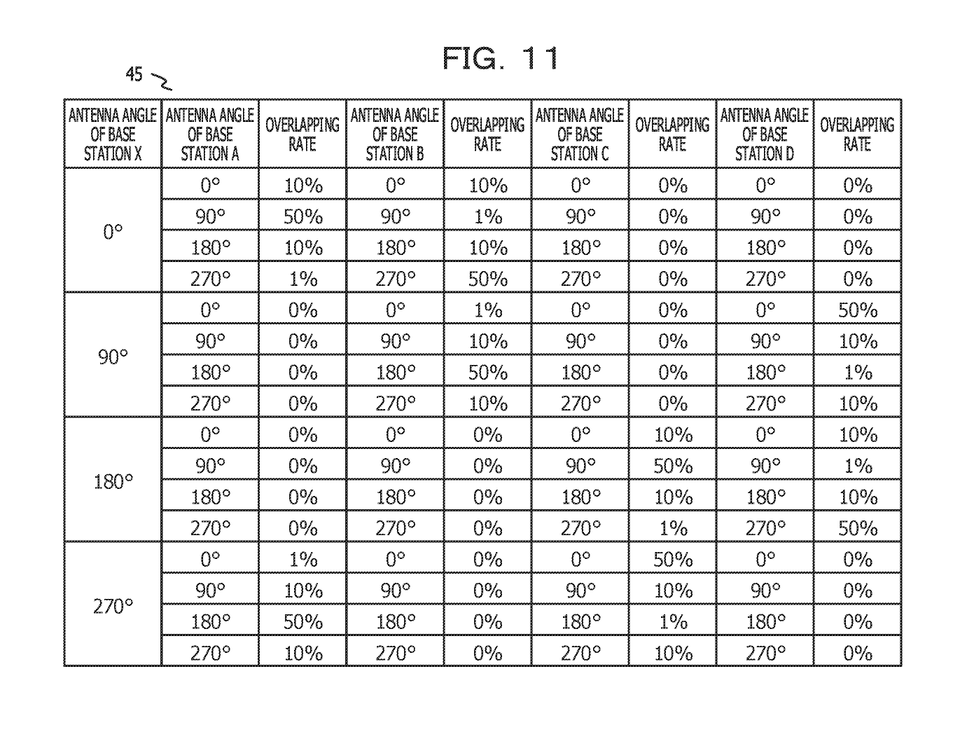

FIG. 11 illustrates one example of the coverage information table 45 in the present embodiment. The coverage information table 45 is stored in a memory device the mobile base station 28 has. The coverage information table 45 includes the antenna angle of the mobile base station X, the antenna angles of mobile base stations adjacent to the mobile base station X (e.g. mobile base stations A to D), and the overlapping rates of the coverage area corresponding to the angles of the antennas of the adjacent mobile base stations. In FIG. 11, an example in which the angle in each mobile base station is quartered (0°, 90°, 180°, and 270°) is illustrated.

For example, suppose that the filter node 26 is notified of the following antenna angles as the antenna state change information: the antenna angle of the base station X=0°; the antenna angle of the base station A=90°; the antenna angle of the base station B=270°, the antenna angle of the base station C=0°, and the antenna angle of the base station D=0°. In this case, on the basis of the antenna state change information, the coverage information acquiring unit 44 acquires the coverage information (base station A: 50%, base station B: 50%, base station C: 0%, and base station D: 0%) from the coverage information table 45.

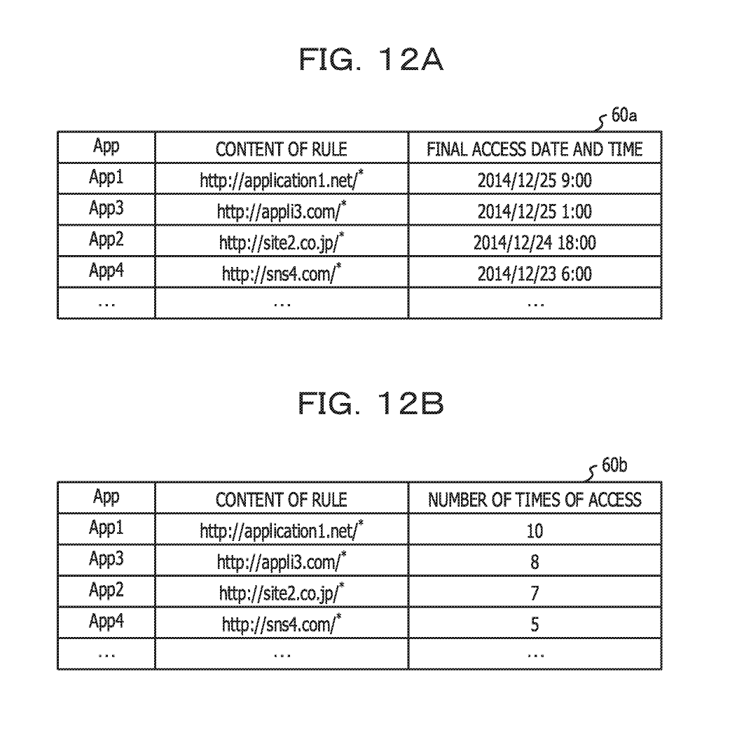

FIG. 12A and FIG. 12B illustrate one example of the rule table in the present embodiment. The rule table 60 is stored in a memory device the filter node 26 has. FIG. 12A is a rule table 60a when the above-described method 1 is employed. FIG. 12B is a rule table 60b when the above-described method 2 is employed.

FIG. 12A is a rule table example when filter rules are managed by the LRU method. In the case of FIG. 12A, the rule table 60a includes data items of “application name,” “contents of rule,” and “final access date and time.” In “application name,” the name (or identification information) of the application is stored. In “contents of rule,” the rule corresponding to the application, e.g. information on the access destination or the like of the application, is stored. In “final access date and time,” the final date and time when the access destination is accessed is stored.

FIG. 12B is a rule table example when filter rules are managed by the LFU method. In the case of FIG. 12B, the rule table 60b includes data items of “application name,” “contents of rule,” and “the number of times of access.” In “application name,” the name (or identification information) of the application is stored. In “contents of rule,” the rule corresponding to the application, e.g. information on the access destination or the like of the application, is stored. In “the number of times of access,” the number of times of access to the access destination is stored.

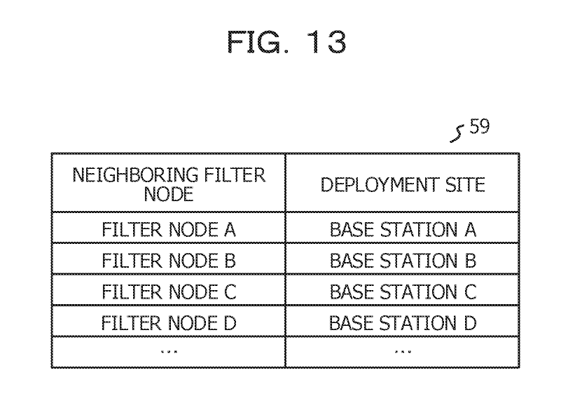

FIG. 13 illustrates one example of the filter node deployment state DB in the present embodiment. The filter node deployment state DB 59 is stored in the memory device the filter node 26 has. The filter node deployment state DB 59 includes data items of “neighboring filter node” and “deployment site.” In “neighboring filter node,” the name of the filter node existing in the vicinity of the base station X storing this filter node deployment state DB 59 is stored. In “deployment site,” the name of the base station on which the filter node is deployed is stored.

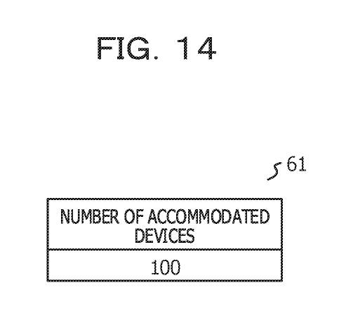

FIG. 14 illustrates one example of the number-of-accommodated-devices table in the present embodiment. The number-of-accommodated-devices table 61 is stored in the memory device the filter node 26 has, and is used when the above-described method 2 is employed. The number-of-accommodated-devices table 61 includes a data item of “the number of accommodated devices.” “The number of accommodated devices” indicates the number of smart devices accommodated by the filter node, i.e. the number of smart devices coupled to a network via this filter node.

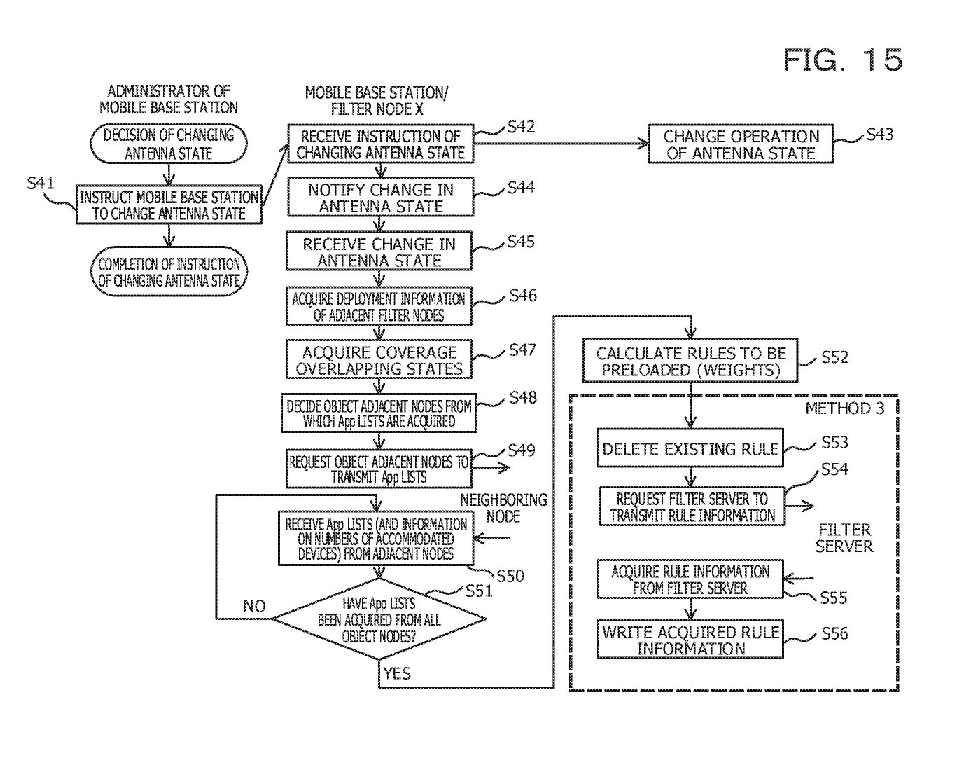

FIG. 15 illustrates the flow of preloading processing of filter rule information when the antenna state is changed in the present embodiment.

A mobile base station administrator instructs the mobile base station 28 to change the antenna state such as the coverage by using an input device of the mobile base station 28 (S41).

In the mobile base station 28, the antenna state change receiving unit 41 receives instruction information that indicates changing the coverage of the antenna of the mobile base station 28 from the mobile base station administrator (S42). The antenna state changing unit 42 changes the state of the antenna on the basis of the instruction information (S43).

The notifying unit 43 notifies the filter node 26 of information about the change in the state of the antenna (antenna state change information) (S44). The antenna state change information includes the antenna angle of the base station X and the antenna angles of base stations adjacent to the base station X, e.g. the base stations A to D.

The notification receiving unit 51 receives the antenna state change information from the notifying unit 43 and requests the coverage information acquiring unit 44 to transmit the coverage information on the basis of the antenna state change information. The notification receiving unit 51 acquires the coverage information from the coverage information acquiring unit 44 (S45).

The App list acquiring unit 52 acquires information on base stations on which adjacent filter nodes are deployed (deployment information) from the filter node deployment state DB 59 (S46). The App list acquiring unit 52 acquires the overlapping states (overlapping rates) between the coverage area of the relevant mobile base station and the coverage area of the adjacent mobile base station (filter node) from the deployment information of the filter nodes and the coverage information as described with FIG. 11 (S47).

On the basis of the overlapping rates, the App list acquiring unit 52 decides object adjacent nodes from which App lists corresponding to filter rules are acquired from the adjacent filter nodes (S48). Here, the App list acquiring unit 52 decides adjacent filter nodes whose overlapping rate is higher than 0% as the object adjacent nodes.

The App list acquiring unit 52 requests the object adjacent nodes to transmit the App lists (S49). The App list acquiring unit 52 receives the App lists (and information on the numbers of accommodated devices, in the case of method 2) from the adjacent nodes (S50). The App list acquiring unit 52 determines whether or not the App lists have been acquired from all object adjacent nodes (S51).

If the App lists have been acquired from all object adjacent nodes (S51: YES), the preloading target rule calculating unit 53 executes the following processing. In other words, the preloading target rule calculating unit 53 calculates the use rate (weight) of each application on the basis of the App lists (and information on the numbers of accommodated devices, in the case of method 2) and the overlapping rates (S52). The processing of S52 is omitted because the processing has been explained with FIG. 5 and FIG. 6.

The filter unit 54 deletes rule information stored in the rule table 60 (S53). The rule acquiring unit 57 requests the filter server 23 to transmit rule information according to the calculated use rate (weight) of each application (S54).

The rule acquiring unit 57 acquires the rule information of the application from the filter server 23 (S55). The filter unit 54 stores the acquired rule information of the application in the rule table 60 (S56).

Details of S53 to S56 will be described later as method 3 (collective acquisition/individual acquisition of rule information) as described with FIG. 7.

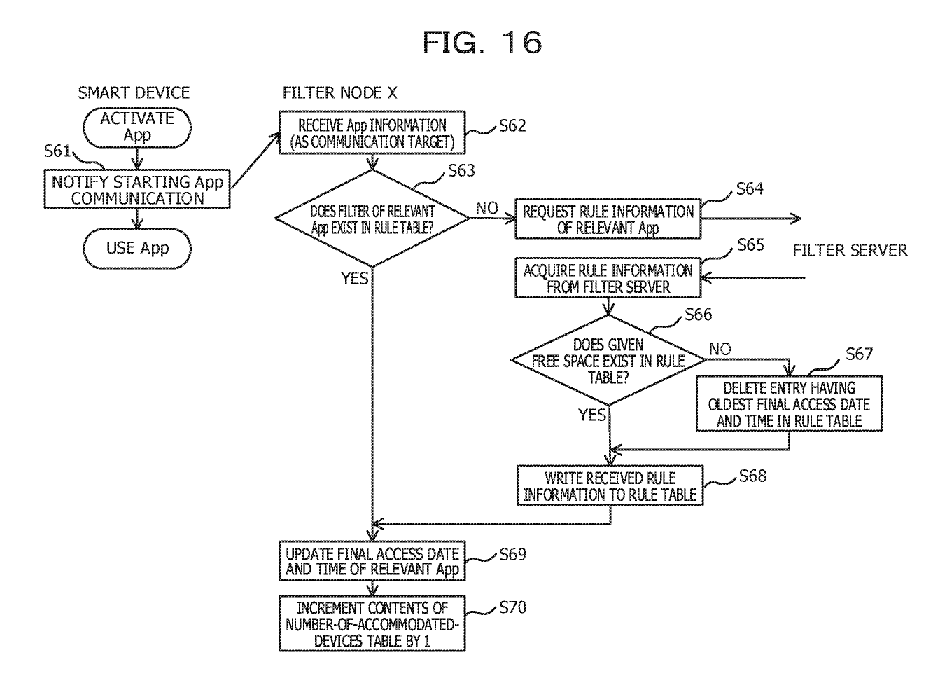

FIG. 16 illustrates the flow of start processing of application use in the smart device in the case in which the rule table is managed by the LRU method in the present embodiment.

The smart device 29 makes a notification that indicates starting communication (including information to identify an application (App information)) to the filter node X by using the application installed in this smart device 29 (S61).

In the filter node X, the communication unit (smart device side) 55 receives the notification that indicates starting communication (including the App information) from the smart device 29 (S62). Thereupon, the filter unit 54 determines whether or not the filter rule (rule information) corresponding to the received App information exists in the rule table 60a (S63).

If the rule information corresponding to the received App information does not exist in the rule table 60a (S63: NO), the rule acquiring unit 57 requests the filter server 23 to transmit the rule information corresponding to the App information (S64). The rule acquiring unit 57 acquires the rule information of the application from the filter server 23 (S65).

The filter unit 54 determines whether or not a given free space exists in the rule table 60a (S66). If the given free space does not exist in the rule table 60a (S66: NO), the filter unit 54 deletes the entry having the oldest final access date and time in the rule table 60a (S67).

If the given free space exists in the rule table 60a (S66: YES) or after the end of the processing of S67, the filter unit 54 writes the rule information received from the filter server 23 to the rule table 60a (S68).

If the rule information corresponding to the received App information exists in the rule table 60a (S63: YES) or after the end of the processing of S68, the filter unit 54 applies the rule information corresponding to the received App information. The communication unit (outside) 56 communicates with an external network on the basis of the applied rule information.

The filter unit 54 updates the date and time of the final access to the communication destination corresponding to the rule information of the relevant App in the rule table 60a (S69). The filter unit 54 adds +1 to the number of accommodated devices in the number-of-accommodated-devices table 61 (S70).

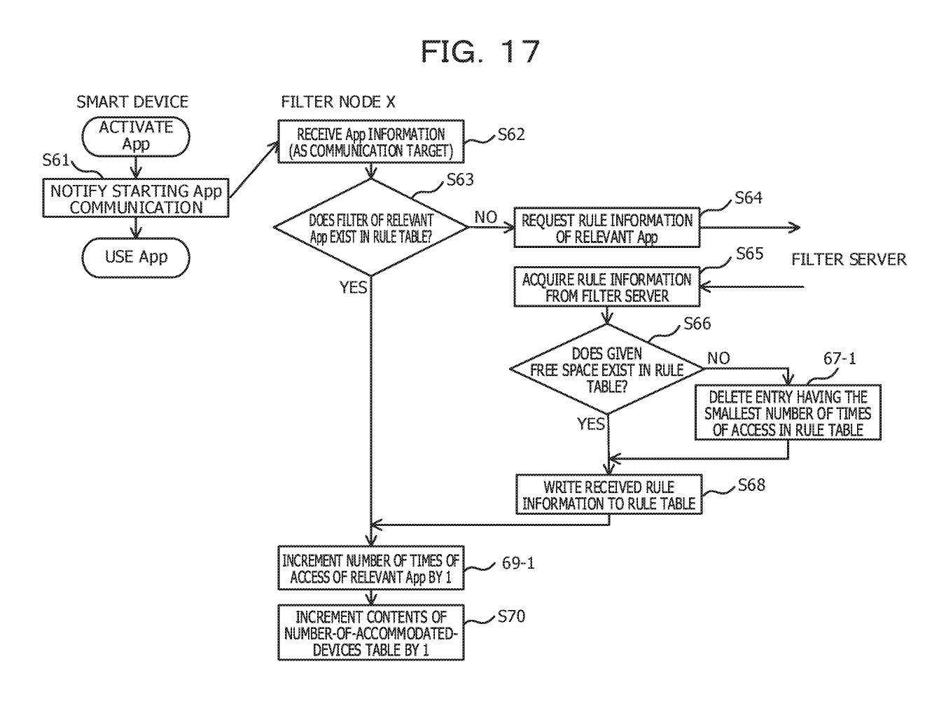

FIG. 17 illustrates the flow of start processing of application use in the smart device in the case in which the rule information is managed by the LFU method in the present embodiment. The flow of FIG. 17 is obtained by replacing S67 and S69 in the flow of FIG. 16 by S67-1 and S69-1.

If a given free space does not exist in the rule table 60b in S66 (S66: NO), the filter unit 54 deletes the entry having the smallest number of times of access in the rule table 60b (S67-1).

If the given free space exists in the rule table 60b (S66: YES) or after the end of the processing of S67-1, the filter unit 54 writes rule information received from the filter server 23 to the rule table 60b (S68).

If the rule information corresponding to the received App information exists in the rule table 60b (S63: YES) or after the end of the processing of S68, the filter unit 54 applies the rule information corresponding to received App information. The communication unit (outside) 56 communicates with an external network on the basis of the applied rule information.

The filter unit 54 adds +1 to the number of times of access to the communication destination corresponding to the rule information of the relevant App in the rule table 60b (S69-1). The filter unit 54 adds +1 to the number of accommodated devices in the number-of-accommodated-devices table 61 (S70).

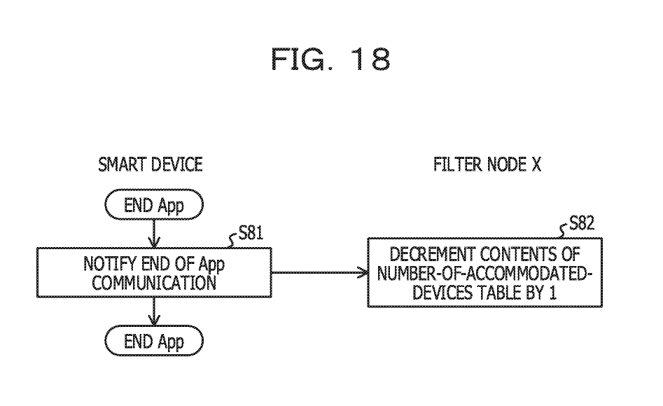

FIG. 18 illustrates the flow of end processing of application use in the smart device in the present embodiment.

The smart device 29 notifies the filter node X of the end of communication using a given application (S81).

In the filter node X, the communication unit (outside) 56 ends communication with an external network in response to the notification of the end of the communication. The filter unit 54 decrements the number of accommodated devices in the number-of-accommodated-devices table 61 (S82).

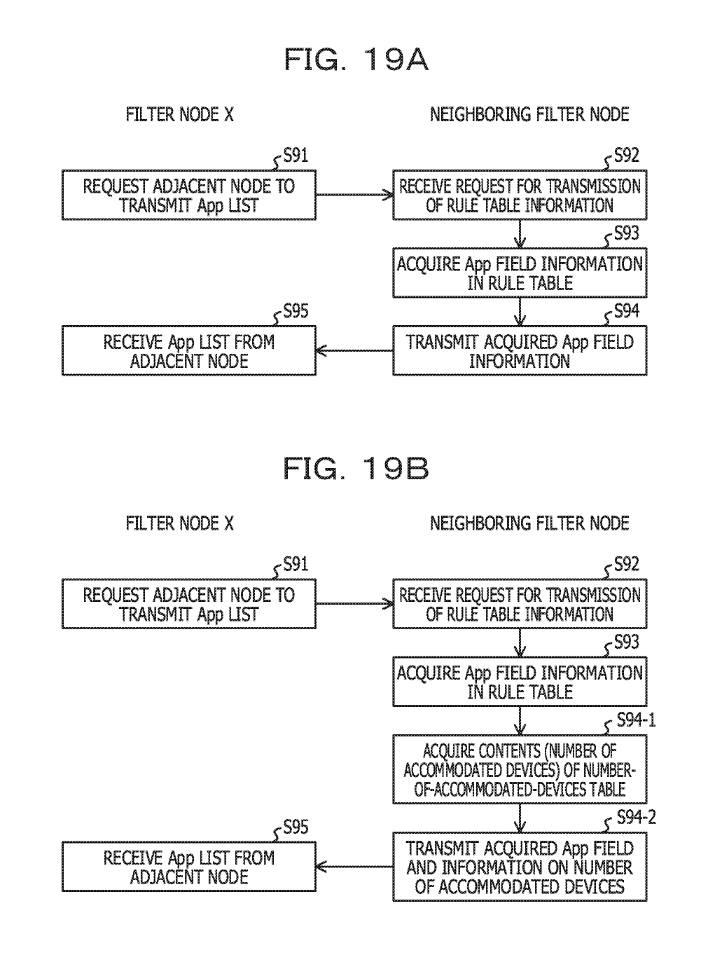

FIG. 19A and FIG. 19B illustrate flows of transmission processing of an App list in the present embodiment.

FIG. 19A illustrates the flow of the transmission processing of an App list when method 1 is employed. In the filter node X, the App list acquiring unit 52 requests an object adjacent node to transmit an App list (S91).

In the object adjacent node, the App list transmitting unit 58 receives the request for transmission of the App list from the filter node X (S92). Thereupon, the App list transmitting unit 58 acquires application names stored in the item of “App” in the rule table 60 (S93) and transmits the application names as the App list to the filter node X (S94).

In the filter node X, the App list acquiring unit 52 receives the App list transmitted from the object adjacent node (S95).

FIG. 19B illustrates the flow of the transmission processing of an App list when method 2 is employed. In the filter node X, the App list acquiring unit 52 requests an object adjacent node to transmit an App list (S91).

In the object adjacent node, the App list transmitting unit 58 receives the request for transmission of the App list from the filter node X (S92). Thereupon, the App list transmitting unit 58 acquires a list of the application name (App list) stored in the item of “App” in the rule table 60 (S93).

Moreover, the App list transmitting unit 58 acquires the number of accommodated devices from the number-of-accommodated-devices table 61 (S94-1).

The App list transmitting unit 58 transmits the App list and the information on the number of accommodated devices to the filter node X (S94-2).

In the filter node X, the App list acquiring unit 52 receives the App list and the information on the number of accommodated devices transmitted from the object adjacent node (S95).

Next, an embodiment of method 3 described with FIG. 7, i.e. a method of filter rule acquisition (collective acquisition or individual acquisition) from the filter server, will be described.

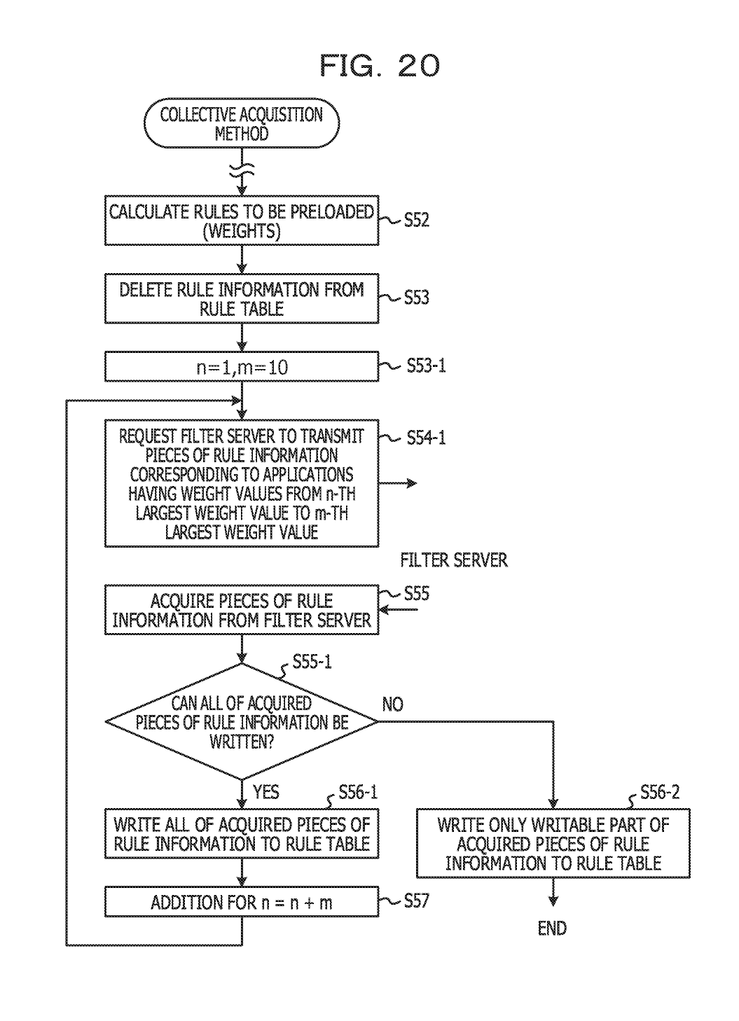

FIG. 20 illustrates the processing flow of the collective acquisition of filter rules from the filter server in the present embodiment. FIG. 20 illustrates processing after the weight calculation processing (S52 in FIG. 15) in the mobile base station or the filter node X.

The preloading target rule calculating unit 53 calculates the use rate (weight) of each application on the basis of App lists (and information on the numbers of accommodated devices, in the case of method 2) acquired from object adjacent nodes (S52).

The filter unit 54 deletes rule information stored in the rule table 60 (S53).

Here, variables n=1 and m=10 are set as one example (S53-1).

According to the calculated use rates (weights), the rule acquiring unit 57 requests the filter server 23 to transmit pieces of rule information corresponding to applications having weight values from the n-th largest weight value to the m-th largest weight value (S54-1).

The rule acquiring unit 57 acquires the pieces of rule information of the applications from the filter server 23 in response to the request (S55).

The filter unit 54 determines whether or not the size of the acquired pieces of rule information falls within the allowable capacity of the rule table 60, i.e. whether all of the acquired pieces of rule information can be written to the rule table 60 (S55-1).

If the size of the acquired pieces of rule information falls within the allowable capacity of the rule table 60 (S55-1: YES), the filter unit 54 writes all of the acquired pieces of rule information to the rule table 60 (S56-1). The filter unit 54 substitutes the value of n+m into n (S57) and repeats the processing of S54-1 to S57 until the size of acquired pieces of rule information surpasses the allowable capacity of the rule table 60.

If the size of the acquired pieces of rule information surpasses the allowable capacity of the rule table 60 (S55-1: NO), the filter unit 54 writes only the writable part of the acquired pieces of rule information to the rule table 60 (S56-2).

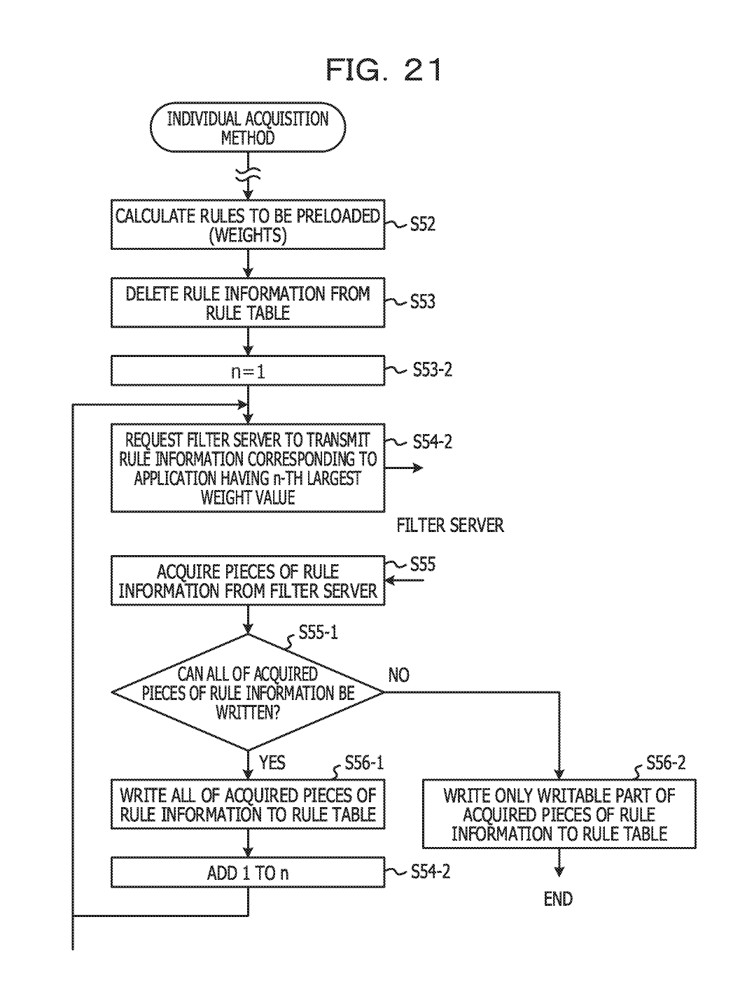

FIG. 21 illustrates the processing flow of the individual acquisition of filter rules from the filter server in the present embodiment. FIG. 21 illustrates processing after the weight calculation processing (S52 in FIG. 15) in the mobile base station or the filter node X.

The preloading target rule calculating unit 53 calculates the use rate (weight) of each application on the basis of App lists (and information on the numbers of accommodated devices, in the case of method 2) acquired from object adjacent nodes (S52).

The filter unit 54 deletes existing rule information stored in the rule table 60 (S53).

Here, a variable n=1 is set as one example (S53-2).

According to the calculated use rates (weights), the rule acquiring unit 57 requests the filter server 23 to transmit rule information corresponding to an application having the n-th largest weight value (S54-2).

The rule acquiring unit 57 acquires the rule information of the application from the filter server 23 in response to the request (S55).

The filter unit 54 determines whether or not the size of the acquired pieces of rule information falls within the allowable capacity of the rule table 60, i.e. whether all of the acquired pieces of rule information can be written to the rule table 60 (S55-1).

If the size of the acquired pieces of rule information falls within the allowable capacity of the rule table 60 (S55-1: YES), the filter unit 54 writes all of the acquired pieces of rule information to the rule table 60 (S56-1). The filter unit 54 increments the value of n (S57-1) and repeats the processing of S54-2 to S57-1 until the size of acquired pieces of rule information surpasses the allowable capacity of the rule table 60.

If the size of the acquired pieces of rule information surpasses the allowable capacity of the rule table 60 (S55-1: NO), the filter unit 54 writes only the writable part of the acquired pieces of rule information to the rule table 60 (S56-2).

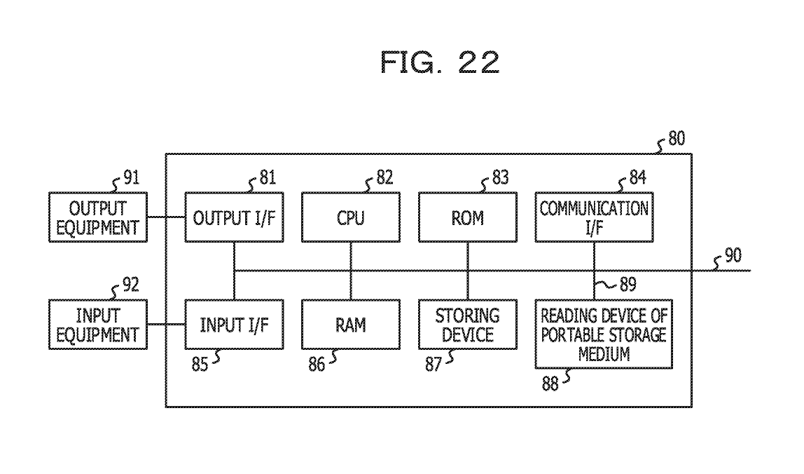

FIG. 22 is one example of a configuration block diagram of the hardware environment of a computer that executes a program in the present embodiment. A computer 80 functions as a mobile base station 28. The computer 80 is configured by a CPU 82, a ROM 83, a RAM 86, a communication I/F 84, a storing device 87, an output I/F 81, an input I/F 85, a reading device 88, a bus 89, output equipment 91, and input equipment 92.

Here, the CPU denotes a central processing unit. The ROM denotes a read only memory. The RAM denotes a random access memory. The I/F denotes an interface. To the bus 89, the CPU 82, the ROM 83, the RAM 86, the communication I/F 84, the storing device 87, the output I/F 81, the input I/F 85, and the reading device 88 are coupled. The reading device 88 is a device that reads out a portable recording medium. The output equipment 91 is coupled to the output I/F 81 and the input equipment 92 is coupled to the input I/F 85.

As the storing device 87, storing devices of various forms, such as hard disk, flash memory, and magnetic disk, may be used. In the storing device 87 or the ROM 83, a program that causes the CPU 82 to function as the identification information acquiring unit 12, the regulation information acquiring unit 13, and the regulating unit 14 and is related to the present embodiment is stored. For example, a program that causes the CPU 82 to function as the antenna state change receiving unit 41, the antenna state changing unit 42, the notifying unit 43, the coverage information acquiring unit 44, and the filter node 26 and is related to the present embodiment is stored.

Furthermore, the storing device 87 stores the coverage information table 45, the filter node deployment state DB 59, the rule table 60, the number-of-accommodated-devices table 61, and so forth. Information is temporarily stored in the RAM 86.

The CPU 82 reads out the program according to the present embodiment from the storing device 87 or the ROM 83 and executes this program.

The communication I/F 84 is an interface such as a port for being coupled to a network and communicating with another piece of equipment.

The program that implements the processing explained in the above-described embodiment may be stored in e.g. the storing device 87 from the program provider side via a communication network 90 and the communication I/F 84. Furthermore, the program that implements the processing explained in the above-described embodiment may be stored in a portable storage medium that is commercially available and is distributed. In this case, this portable storage medium may be set in the reading device 88 and the program may be read out to be executed by the CPU 82. As the portable storage medium, storage media of various forms, such as CD-ROM, flexible disk, optical disk, magneto-optical disk, IC card, USB memory device, and semiconductor memory card, can be used. The program stored in such as a storage medium is read by the reading device 88.

As the input equipment 92, key board, mouse, electronic camera, web camera, microphone, scanner, sensor, tablet, touch panel, and so forth can be used. Furthermore, as the output equipment 91, display, printer, speaker, and so forth can be used.

The network 90 is coupled to a business network 21. The network 90 may be a communication network such as the Internet, LAN, WAN, dedicated line, wired line, or wireless line.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A communication system comprising:
an information processing apparatus including a memory and a processor coupled to the memory and configured to store a plurality of filter rules corresponding to respective application programs;
a first base station configured to cover a first area; and
a second base station configured to cover a second area overlapping the first area, wherein
the second base station is configured to:
couple to a terminal device located in the second area,
store a first filter rule corresponding to a first application program, and
filter a communication caused when the terminal device executes the first application program, and
the first base station is configured to:
acquire, from the second base station, application program information indicating the first application program,
determine whether to acquire, from the information processing apparatus, the first filter rule corresponding to the first application program indicated by the application program information based on a first overlapping state of the first area and the second area, and
acquire, based on the determination, the first filter rule from the information processing apparatus.

2. The communication system according to claim 1, wherein the first base station is further configured to:
filter, by applying the first filter rule acquired from the information processing apparatus, a communication caused by executing the first application program by a terminal device coupled to the first base station.

3. The communication system according to claim 1, wherein
the determination whether to acquire the first filter rule is based on a first overlapping rate of the first area and the second area.

4. The communication system according to claim 3, further comprising:
a third base station configured to:
cover a third area overlapping the first area,
store a second filter rule corresponding to a second application program, and
filter a communication caused when a terminal device coupled to the third base station executes the second application program, wherein
the first base station is configured to select the first filter rule to be acquired based on the first overlapping rate of the first area and the second area and a second overlapping rate of the first area and the third area.

5. The communication system according to claim 4, wherein
the selection of the first filter rule is based on the first overlapping rate, the second overlapping rate, a first number of terminal devices coupled to the second base station and a second number of terminal devices coupled to the third base station.

6. The communication system according to claim 5, wherein the first base station is further configured to:
calculate a use rate of the first application program and calculate a use rate of the second application program based on the first overlapping rate, the second overlapping rate, the first number of terminal devices coupled to the second base station and the second number of terminal devices coupled to the third base station, wherein
the first base station acquires the first filter rule from the information processing apparatus prior to the second filter rule when the use rate of the first application program is higher than the use rate of the second application program.

7. The communication system according to claim 1, wherein the first base station is further configured to:
generate a rule table associating the first filter rule corresponding to the first application program and a final access time of the first application program, and
delete the first filter rule when data capacity of the rule table is insufficient and the final access time of the first application program is a least recent time.

8. The communication system according to claim 1, wherein the first base station is further configured to:
generate a rule table associating the first filter rule corresponding to the first application program and a number of access times of the first application program, and
delete the first filter rule when data capacity of the rule table is insufficient and the number of access times of the first application program is a least number of times.

9. A method of acquiring a filter rule, the method comprising:
storing, in an information processing apparatus, a plurality of filter rules corresponding to respective application programs;
acquiring by a first base station covering a first area, application program information indicating a first application program from a second base station covering a second area overlapping the first area, the second base station storing the first filter rule corresponding to a first application program and filtering a communication caused when a terminal device coupled to the second station executes the first application program;
determining by the first base station, whether to acquire the first filter rule corresponding to the first application program indicated by the application program information from the information processing apparatus based on a first overlapping state of the first area and the second area; and
acquiring by the first base station, based on the determining, the first filter rule from the information processing apparatus.

10. The method according to claim 9, further comprising:
filtering, by applying the first filter rule acquired by the first base station from the information processing apparatus, a communication caused by executing the first application program by a terminal device coupled to the first base station.

11. The method according to claim 9, wherein
the determining is based on a first overlapping rate of the first area and the second area.

12. The method according to claim 11, further comprising:
covering, by a third base station, a third area overlapping the first area;
storing, by the third base station, a second filter rule corresponding to a second application program;
filtering, by the third base station, a communication caused when a terminal device coupled to the third base station executes the second application program; and
selecting, by the first base station, the first filter rule to be acquired based on the first overlapping rate of the first area and the second area and a second overlapping rate of the first area and the third area.

13. The method according to claim 12, wherein
the selecting is based on the first overlapping rate, the second overlapping rate, a first number of terminal devices coupled to the second base station and a second number of terminal devices coupled to the third base station.

14. The method according to claim 13, further comprising:
calculating a use rate of the first application program and calculating a use rate of the second application program based on the first overlapping rate, the second overlapping rate, the first number of terminal devices coupled to the second base station and the second number of terminal devices coupled to the third base station, wherein
in the acquiring, the first base station acquires the first filter rule from the information processing apparatus prior to the second filter rule when the use rate of the first application program is higher than the use rate of the second application program.

15. A base station comprising:
a memory; and
a processor coupled to the memory and configured to:
cover a first area,
acquire, from another base station, application program information indicating a first application program, the another base station covering a second area overlapping the first area, being coupled to a terminal device located in the second area, storing a first filter rule corresponding to the first application program, and filtering a communication caused when the terminal device executes the first application program,
determine whether to acquire, from an information processing apparatus storing a plurality of filter rules corresponding to respective application programs, the first filter rule corresponding to the first application program indicated by the application program information based on a first overlapping state of the first area and the second area, and
acquire, based on the determination, the first filter rule from the information processing apparatus.

16. The base station according to claim 15, wherein the processor is further configured to:
filter, by applying the first filter rule acquired from the information processing apparatus, a communication caused by executing the first application program by a terminal device coupled to the base station.

17. The base station according to claim 15, wherein
the determination whether to acquire the first filter rule is based on a first overlapping rate of the first area and the second area.

18. The base station according to claim 17, wherein the processor is further configured to:
select the first filter rule to be acquired based on the first overlapping rate of the first area and the second area and a second overlapping rate of the first area and a third area, an other base station being configured to cover the third area overlapping the first area, store a second filter rule corresponding to a second application program, and filter a communication caused when a terminal device coupled to the other base station executes the second application program.

19. The base station according to claim 18, wherein
the selection of the first filter rule is based on the first overlapping rate, the second overlapping rate, a first number of terminal devices coupled to the another base station and a second number of terminal devices coupled to the other base station.

20. The base station according to claim 19, wherein the processor is further configured to:
calculate a use rate of the first application program and calculate a use rate of the second application program based on the first overlapping rate, the second overlapping rate, the first number of terminal devices coupled to the another base station and the second number of terminal devices coupled to the other base station, and
acquire the first filter rule from the information processing apparatus prior to the second filter rule when the use rate of the first application program is higher than the use rate of the second application program.
